(19) United States
(12) Patent Application Publication
(10) Pub. No.: US 2026/0148342 A1
(43) Pub. Date: May 28, 2026

(54) ELECTRONIC DEVICE AND EXPOSURE CONTROL METHOD FOR GENERATING HIGH DYNAMIC RANGE IMAGE THEREOF

(71) Applicant: ASUSTeK COMPUTER INC., Taipei City (TW)

(72) Inventors: Miao-Wei Wang, Taipei City (TW); Hsiu-Ting Yang, Taipei City (TW); Hsin-Chih Wang, Taipei City (TW)

(73) Assignee: ASUSTeK COMPUTER INC., Taipei City (TW)

(21) Appl. No.: 19/190,817

(22) Filed: Apr. 28, 2025

(30) Foreign Application Priority Data
Nov. 27, 2024 (TW) 113145670

(51) Int. Cl. G06T 5/50; G06V 10/12; H04N 23/743

(52) U.S. Cl. CPC G06T 5/50; G06V 10/12; H04N 23/743; G06T 2207/20208

(57) ABSTRACT

The present application discloses an electronic device and an exposure control method for generating a high dynamic range image thereof. A first image is acquired according to an initial exposure value via an image capture device. Cumulative distribution functions of color channels and a luminance channel are generated according to the first image. According to the cumulative distribution functions of the color channels and the luminance channel, whether an exposure state of each color channel is overexposed or underexposed is determined. When the exposure state of one of the color channels is overexposed or underexposed, a target exposure value is determined according to the cumulative distribution functions of the one of the color channels and the luminance channel. A second image is captured according to the target exposure value, and a high dynamic range image is synthesized using the first image and the second image.

### CROSS-REFERENCE TO RELATED APPLICATION

This application claims the priority benefit of Taiwan application serial no. 113145670, filed on Nov. 27, 2024. The entirety of the above-mentioned patent application is hereby incorporated by reference herein and made a part of this specification.

### BACKGROUND OF THE INVENTION

### Field of the Invention

The disclosure relates to an electronic device and an exposure control method for generating a high dynamic range image thereof.

### Description of Related Art

With the advancement of technology, electronic equipment having camera function has become part of modern people's lives. At present, the camera function is significantly improved, and significant improvements are made in all of shutter speed, aperture size, focusing speed, and image processing speed. However, since the range of various colors and luminance in real scenes is very large, but the dynamic range of image sensors is much smaller than the dynamic range visible to the human eye, the image generated by the image sensors in some scenes is significantly different from the actual perception of the naked eye. For example, if the photo scene contains both high-luminance and low-luminance areas, the captured image may have an issue such as a dark area being too dark or a bright area being overexposed.

Currently, in order to improve the dynamic range of photo imaging, an overall clear high dynamic range image may be synthesized using a plurality of images taken according to different exposure settings. However, if the exposure settings are determined only according to the luminance information of the shooting scene, the color channel information in the scene is readily ignored, resulting in color cast phenomenon in the synthesized high dynamic range image.

### SUMMARY OF THE INVENTION

The disclosure provides an exposure control method for generating a high dynamic range image used in an electronic device including an image capture device. The method includes following steps. A first image is acquired according to an initial exposure value via an image capture device. Cumulative distribution functions of a plurality of color channels and a cumulative distribution function of a luminance channel are generated according to the first image. According to the cumulative distribution functions of the plurality of color channels and the cumulative distribution function of the luminance channel, whether an exposure state of each color channel is overexposed or underexposed is determined. When the exposure state of one of the plurality of color channels is overexposed or underexposed, a target exposure value is determined according to the cumulative distribution function of the one of the plurality of color channels and the cumulative distribution function of the luminance channel. A second image is captured according to the target exposure value, and a high dynamic range image is synthesized using the first image and the second image.

The disclosure further provides an electronic device including an image capture device and a processor. The processor is coupled to the image capture device. The processor is configured to perform following operations. A first image is acquired according to an initial exposure value via the image capture device. Cumulative distribution functions of a plurality of color channels and a cumulative distribution function of a luminance channel are generated according to the first image. According to the cumulative distribution functions of the plurality of color channels and the cumulative distribution function of the luminance channel, whether an exposure state of each color channel is overexposed or underexposed is determined. When the exposure state of one of the plurality of color channels is overexposed or underexposed, a target exposure value is determined according to the cumulative distribution function of the one of the plurality of color channels and the cumulative distribution function of the luminance channel. A second image is captured according to the target exposure value, and a high dynamic range image is synthesized using the first image and the second image.

Based on the above, in an embodiment of the disclosure, the exposure state of each color channel may be determined according to the cumulative distribution function of each color channel. When the exposure state of one of the color channels is overexposed or underexposed, the target exposure value is determined according to the cumulative distribution function of the color channel. Thereafter, a high dynamic range image may be synthesized from the images captured according to the target exposure value. Accordingly, the high dynamic range image may highly restore the scene color.

### BRIEF DESCRIPTION OF THE DRAWINGS

FIG. 1 is a schematic block diagram of an electronic device shown according to an embodiment of the disclosure.

FIG. 2 is a flowchart of an exposure control method for generating a high dynamic range image shown according to an embodiment of the disclosure.

FIG. 3 is a flowchart of determining whether the exposure state of a plurality of color channels is overexposed or underexposed shown according to an embodiment of the disclosure.

FIG. 4 is a schematic diagram of cumulative distribution functions of a plurality of color channels shown according to an embodiment of the disclosure.

FIG. 5 is a flowchart of determining a target exposure value shown according to an embodiment of the disclosure.

FIG. 6 is a schematic diagram of generating a high dynamic range image shown according to an embodiment of the disclosure.

### DESCRIPTION OF THE EMBODIMENTS

Reference will now be made in detail to the exemplary embodiments of the disclosure, and examples of the exemplary embodiments are illustrated in the accompanying drawings. Wherever possible, the same reference numerals are used in the figures and the descriptions to refer to the same or similar portions. The embodiments are a portion of the disclosure, and do not disclose all possible implementation modes of the disclosure. Rather, the embodiments are merely examples of devices and methods within the scope of the disclosure.

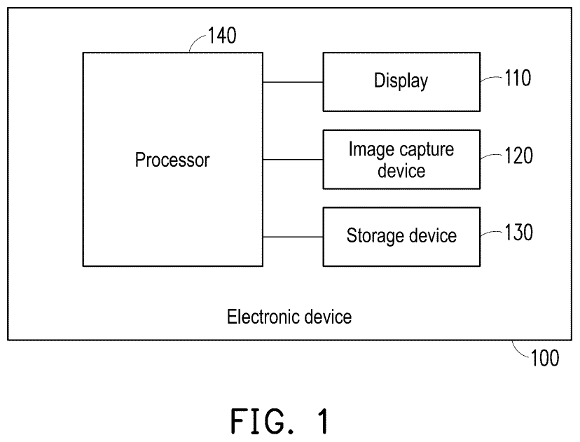

Referring to FIG. 1, an electronic device 100 may include a display 110, an image capture device 120, a storage device 130, and a processor 140. The electronic device 100 may be, for example, various electronic equipment having image capturing function such as a smart phone, a digital camera, a tablet computer, a game console, an electronic wearable device, or a photographic device, and the type of the electronic device 100 is not limited thereto.

The display 110 may be various displays such as a liquid-crystal display (LCD), a light-emitting diode (LED) display, an organic light-emitting diode (OLED), and the disclosure is not limited thereto. The display 110 may be used to display a program operation interface of a camera application, a preview screen, or a composite image, etc.

The image capture device 120 is used to capture an image, and may include a lens, an image sensor, and other components. The lens may include an optical lens for controlling the optical path. The image sensing element is used to provide an image sensing function. The image sensing element may include a photosensitive element, such as a charge-coupled device (CCD), a complementary metal-oxide semiconductor (CMOS) element, or other elements, and the disclosure is not limited thereto. The lens may focus imaging light onto the image sensing element to achieve the object of capturing an image.

The storage device 130 is used to store a file, an image, a command, a program code, a software module, etc., and may be, for example, any type of fixed or removable random-access memory (RAM), read-only memory (ROM), flash memory, hard disk, or other similar devices, integrated circuits, or a combination thereof.

The processor 140 is coupled to the display 110, the image capture device 120, and the storage device 130, and is, for example, a central processing unit (CPU), an application processor (AP), or other programmable general-purpose or special-purpose microprocessors, digital signal processors (DSPs), image signal processors (ISPs), graphics processing units (GPUs), or other similar devices, integrated circuits, or a combination thereof. In some embodiments, the processor 140 may execute a command or a program code in the storage device 130 to implement each step of an exposure control method for generating a high dynamic range image in an embodiment of the disclosure.

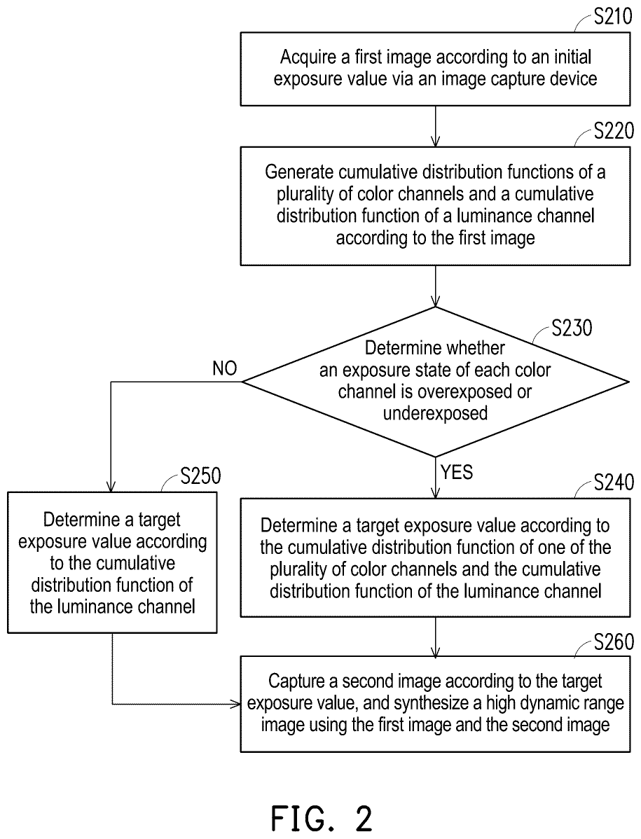

FIG. 2 is a flowchart of an exposure control method for generating a high dynamic range image shown according to an embodiment of the disclosure. Referring to FIG. 2, the method of the present embodiment may be executed by the electronic device 100 of FIG. 1. The following describes the details of each step of FIG. 2 with reference to the elements shown in FIG. 1.

In step S210, the processor 140 acquires a first image according to an initial exposure value (EV) via the image capture device 120. In some embodiments, the processor 140 may execute an automatic exposure (AE) program to acquire an automatic exposure parameter (such as shutter speed and aperture size, etc.), and control the image capture device 120 to capture the first image according to the automatic exposure parameter. The initial exposure value (EV) is the setting value of the automatic exposure parameter calculated by adjusting the automatic exposure program. In some embodiments, the initial exposure value may be +0EV.

In step S220, the processor 140 generates cumulative distribution functions (CDFs) of a plurality of color channels and a cumulative distribution function of a luminance channel (Y channel) according to the first image. Specifically, the processor 140 may count the pixel luminance values of all pixels in the first image to generate a luminance histogram. Next, the processor 140 may generate the cumulative distribution function of the luminance channel according to the luminance histogram. In some embodiments, the luminance channel may be a luminance channel in a YCbCr color space.

In some embodiments, the color channels may include a red channel (R channel), a green channel (G channel), and a blue channel (B channel). Specifically, the processor 140 may first calculate the histogram of each color channel in the first image, and generate a cumulative distribution function of each color channel according to the histogram of each color channel. For example, the processor 140 may generate a cumulative distribution function of the red channel according to the red channel values of all pixels in the first image.

In step S230, the processor 140 determines whether an exposure state of each color channel is overexposed or underexposed according to the cumulative distribution functions of the plurality of color channels and the cumulative distribution function of the luminance channel. Specifically, the processor 140 may determine whether the color channel is overexposed or underexposed in the first image via the comparison result between the cumulative distribution function of a certain color channel and the cumulative distribution function of the luminance channel.

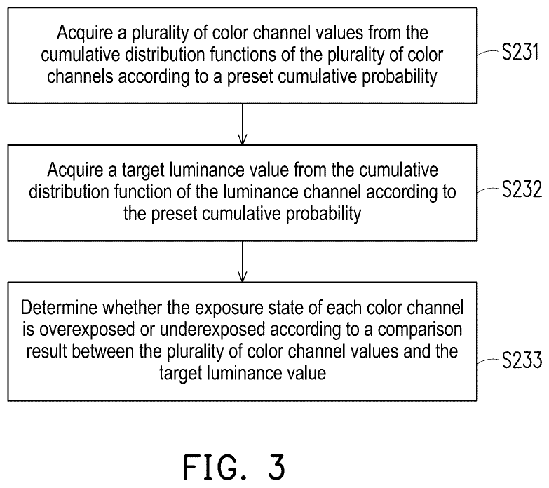

Referring to FIG. 3, FIG. 3 is a flowchart of determining whether the exposure state of a plurality of color channels is overexposed or underexposed shown according to an embodiment of the disclosure. In some embodiments, step S230 may be implemented as step S231 to step S233.

In step S231, the processor 140 acquires a plurality of color channel values from the cumulative distribution functions of the plurality of color channels respectively according to a preset cumulative probability. Specifically, the processor 140 may find one color channel value corresponding to the preset cumulative probability from the cumulative distribution function of each color channel.

When determining whether the exposure state of a certain color channel is overexposed, the preset cumulative probability may be the first preset cumulative probability. The first preset cumulative probability may be, for example, 95%, but may be not limited thereto. The processor 140 may acquire the corresponding first color channel value from the cumulative distribution function of each color channel according to the first preset cumulative probability.

When determining whether the exposure state of a certain color channel is underexposed, the preset cumulative probability may be the second preset cumulative probability. The second preset cumulative probability may be, for example, 10%, but may be not limited thereto. The processor 140 may acquire the corresponding second color channel value from the cumulative distribution function of each color channel according to the second preset cumulative probability.

In step S232, the processor 140 acquires a target luminance value from the cumulative distribution function of the luminance channel according to the preset cumulative probability. The processor 140 may find one target luminance value corresponding to the preset cumulative probability from the cumulative distribution function of the luminance channel.

When determining whether the exposure state of a certain color channel is overexposed, the processor 140 may acquire a corresponding first target luminance value from the cumulative distribution function of the luminance channel according to the first preset cumulative probability. When determining whether the exposure state of a certain color channel is underexposed, the processor 140 may acquire a corresponding second target luminance value from the cumulative distribution function of the luminance channel according to the second preset cumulative probability.

Next, in step S233, the processor 140 determines whether the exposure state of each of the plurality of color channels is overexposed or underexposed according to a comparison result between the plurality of color channel values and the target luminance value. That is, the processor 140 compares each color channel value corresponding to the same preset cumulative probability with the target luminance value. Next, the processor 14 determines the exposure state of the color channel according to the comparison result between a certain color channel value and the target luminance value. For example, according to the comparison result between the red channel value corresponding to the preset cumulative probability and the target luminance value, the processor 140 may determine the exposure state of the red channel.

In some embodiments, when one of the plurality of color channel values is greater than the target luminance value, the processor 140 may determine that the exposure state of one of the color channels is overexposed. Here, the target luminance value is determined according to the first preset cumulative probability. More specifically, when determining whether a certain color channel is overexposed, the processor 140 determines whether the exposure state of each color channel is overexposed according to a comparison result between a plurality of first color channel values corresponding to the first preset cumulative probability and the first target luminance value.

In some embodiments, when one of the plurality of color channel values is smaller than the target luminance value, the processor 140 may determine that the exposure state of one of the color channels is underexposed. Here, the target luminance value is determined according to the second preset cumulative probability. More specifically, when determining whether a certain color channel is underexposed, the processor 140 determines whether the exposure state of each color channel is underexposed according to a comparison result between a plurality of second color channel values corresponding to the second preset cumulative probability and the second target luminance value.

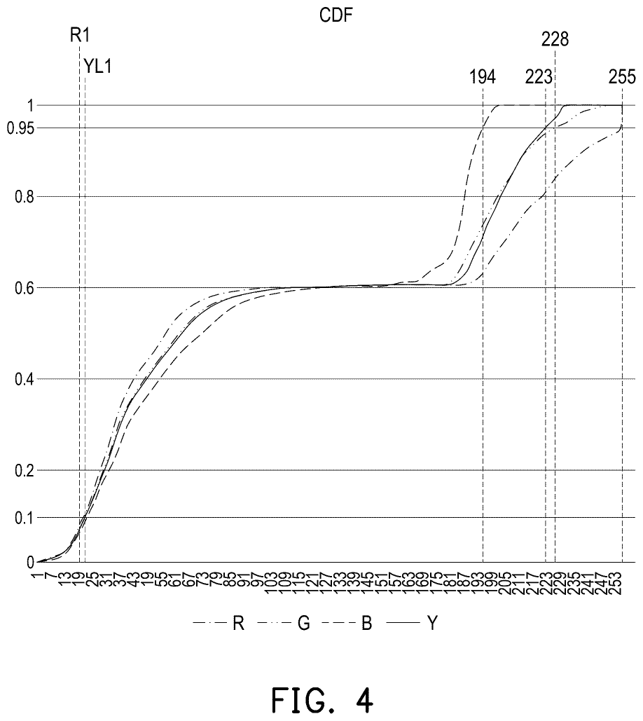

For example, referring to FIG. 4, FIG. 4 is a schematic diagram of cumulative distribution functions of a plurality of color channels shown according to an embodiment of the disclosure. However, FIG. 4 is merely an example for illustrating the disclosure, and is not intended to limit the disclosure.

As shown in FIG. 4, when determining whether the exposure state of each color channel is overexposed, the processor 140 acquires the target luminance value “223” according to the preset cumulative probability “95%”. In addition, the processor 140 acquires the red channel value “255”, the blue channel value “194”, and the green channel value “228” according to the preset cumulative probability “95%”. Since the red channel value “255” is greater than the target luminance value “223”, the processor 140 may determine that the exposure state of the red channel is overexposed. Since the green channel value “228” is greater than the target luminance value “223”, the processor 140 may determine that the exposure state of the green channel is overexposed. Since the blue channel value “194” is not greater than the target luminance value “223”, the processor 140 may determine that the exposure state of the blue channel is not overexposed.

When determining whether the exposure state of each color channel is underexposed, the processor 140 acquires the target luminance value “YL1” according to the preset cumulative probability “10%”. In addition, the processor 140 acquires the red channel value “R1” according to the preset cumulative probability “10%”. Since the red channel value “R1” is smaller than the target luminance value “YL1”, the processor 140 may determine that the exposure state of the red channel is underexposed. Based on the same operation method, the processor 140 may respectively determine whether the exposure state of the green channel and the blue channel is underexposed.

Returning to FIG. 2, when the determination of step S230 is yes, step S240 is executed. In step S240, when the exposure state of one of the plurality of color channels is overexposed or underexposed, the processor 140 determines a target exposure value according to the cumulative distribution function of one of the plurality of color channels and the cumulative distribution function of the luminance channel. In other words, when the exposure state of a certain color channel is overexposed or underexposed, the processor 140 may determine a target exposure value according to the cumulative distribution function of the color channel and the cumulative distribution function of the luminance channel.

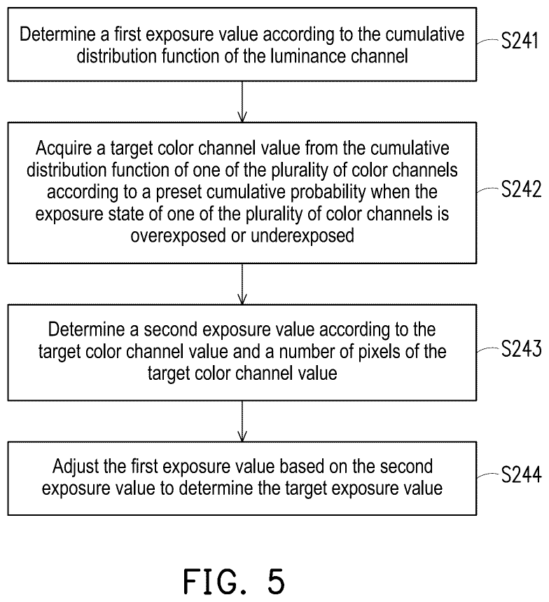

Referring to FIG. 5, FIG. 5 is a flowchart of determining a target exposure value shown according to an embodiment of the disclosure. In some embodiments, step S240 may be implemented as step S241 to step S243.

In step S241, the processor 140 determines a first exposure value according to the cumulative distribution function of the luminance channel. For example, the processor 140 may acquire a target luminance value from the cumulative distribution function of the luminance channel according to the preset cumulative probability (95%). Next, the processor 140 may determine the first exposure value according to the ratio between the target luminance value and the standard luminance value, and the standard luminance value may be set according to actual conditions, which is not limited in the disclosure. For example, the processor 140 may acquire the first exposure value according to the following equation (1).

$$E {V}_{1} = {log}_{2} ( \frac{{Luma}_{Y s}}{{Luma}_{Y}} ) \qquad equation ( 1 )$$

wherein EV₁ represents the first exposure value; Lumd_{Ys} represents the standard luminance value; Luma_{Y} represents the target luminance value.

In step S242, when the exposure state of one of the plurality of color channels is overexposed or underexposed, the processor 140 acquires a target color channel value from a cumulative distribution function of one of the plurality of color channels according to a preset cumulative probability. It should be noted that, in some embodiments, when the exposure state of one or more color channels is overexposed, the processor 140 may determine the maximum value in the plurality of color channels corresponding to the first preset cumulative probability as the target color channel value. In some embodiments, when the exposure state of one or more color channels is underexposed, the processor 140 may determine the minimum value in the plurality of color channels corresponding to the second preset cumulative probability as the target color channel value.

For example, when only the red channel is overexposed, the processor 140 may acquire a red channel value from the cumulative distribution function of the red channel according to the first preset cumulative probability, and use the red channel value as the target color channel value. Or, taking FIG. 4 as an example, when the exposure state of the red channel and the exposure state of the green channel are overexposed, the processor 140 may determine the maximum value in the red channel value and the green channel value corresponding to the first preset cumulative probability as the target color channel value. That is, the target color channel value is the red channel value “255”.

Moreover, taking FIG. 4 as an example, when the exposure state of the red channel and the exposure state of the green channel are both overexposed, the processor 140 may determine the minimum value in the red channel value and the green channel value corresponding to the second preset cumulative probability as the target color channel value. For example, the target color channel value is the red channel value “R1”.

Then, in step S243, the processor 140 determines a second exposure value according to the target color channel value and the number of pixels of the target color channel value. For example, taking FIG. 4 as an example, the processor 140 may determine a second exposure value for reducing the exposure according to the red channel value “255” (i.e., the target color channel value) and the number of pixels of the red channel value “255” in the first image. That is, the second exposure value may be determined according to the overexposure degree of a certain color channel in the first image. Moreover, taking FIG. 4 as an example, the processor 140 may determine a second exposure value for increasing the exposure according to the red channel value “R1” (i.e., the target color channel value) and the number of pixels of the red channel value “R1” in the first image.

In some embodiments, the processor 140 may acquire a target luminance value from the cumulative distribution function of the luminance channel according to the preset cumulative probability. The processor 140 may determine a second exposure value according to the target color channel value, the number of pixels of the target color channel value, the target luminance value, and the number of pixels of the target luminance value. The processor 140 may determine the second exposure value by looking up a table or by a predetermined function.

In some embodiments, the processor 140 may determine the pixel ratio of the target color channel value according to the number of pixels of the target color channel value. For example, when the number of pixels of the target color channel value is N1 and the number of pixels of the first image is M, the pixel ratio of the target color channel value is (N1/M)*100%. The processor 140 may determine the pixel ratio of the target luminance value according to the number of pixels of the target luminance value. The processor 140 may acquire a first product between the target luminance value and the pixel ratio of the target luminance value. The processor 140 may acquire a second product between the target color channel value and the pixel ratio of the target color channel value. The processor 140 may determine the second exposure value according to the ratio between the first product and the second product.

For example, the processor 140 may acquire the second exposure value according to the following equation (2).

$$E {V}_{2} = {log}_{2} ( \frac{{Luma}_{channel} * {Channel}_{percent}}{{Luma}_{Y} * {Y}_{percent}} ) \qquad equation ( 2 )$$

wherein EV₂ represents the second exposure value; Lumd_{Y} represents the target luminance value (e.g., the luminance channel value “223” shown in FIG. 4); Y_{percent} represents the pixel ratio of the target luminance value; Luma_{channel} represents the target color channel value (for example, the red channel value “255” shown in FIG. 4); Channel_{percent} represents the pixel ratio of the target color channel value.

Next, in step S244, the processor 140 adjusts the first exposure value based on the second exposure value to determine the target exposure value.

In some embodiments, when the second exposure value is greater than the adjustment limit value, the processor 140 may determine the target exposure value according to the sum of the adjustment limit value and the first exposure value. When the second exposure value is not greater than the adjustment limit value, the processor 140 may determine the target exposure value according to the sum of the second exposure value and the first exposure value. For example, the processor 140 may acquire the second exposure value according to the following equation (3).

$$\{ \begin{matrix}E {V}_{final} = E {V}_{1} + E {V}_{2} & if \vert {EV}_{2} \vert \leq \vert K \vert \\ E {V}_{final} = E {V}_{1} + K & if \vert {EV}_{2} \vert > \vert K \vert\end{matrix} \qquad equation ( 3 )$$

wherein EV₂ represents the second exposure value; EV₁ represents the first exposure value; EV_{final} represents the target exposure value; and K represents the adjustment limit value.

In some embodiments, the processor 140 may determine the target exposure value according to a weighted sum of the second exposure value and the first exposure value. For example, the processor 140 may determine the target exposure value according to the following equation (4).

$$E {V}_{final} = α * E {V}_{1} + β * E {V}_{2} \qquad equation ( 4 )$$

wherein EV₂ represents the second exposure value; EV₁ represents the first exposure value; α represents the weighted weight of the first exposure value; β represents the weighted weight of the second exposure value; EV_{final} represents the target exposure value.

Returning to FIG. 2, when the determination of step S230 is no, step S250 is executed. In step S250, when the exposure state of one of the plurality of color channels is not overexposed and underexposed, the processor 140 determines a target exposure value according to the cumulative distribution function of the luminance channel. In this step, the operation of determining the target exposure value according to the cumulative distribution function of the luminance channel is similar to the operation of step S241, and is not described in detail herein. That is, when the exposure state of one of the plurality of color channels is not overexposed and underexposed, the processor 140 may determine the target exposure value according to the calculation method of determining the first exposure value of step S241.

In step S260, the processor 140 captures a second image according to the target exposure value, and synthesizes a high dynamic range image using the first image and the second image. Specifically, the image synthesis process performed by the processor 140 is used to synthesize a plurality of images corresponding to different exposure values into one high dynamic range image.

In some embodiments, the processor 140 may generate a target exposure value for increasing the exposure and another target exposure value for decreasing the exposure respectively according to the above description. The processor 140 may control the image capture device to generate a second image having higher overall luminance according to the target exposure value, and control the image capture device to generate another second image having lower overall luminance according to another target exposure value. Next, the processor 140 may synthesize a high dynamic range image according to a plurality of second images corresponding to different target exposure values and the first image corresponding to the initial exposure value. The image algorithm for generating a high dynamic range image may be implemented by any method known to those having ordinary skill in the art, and the present application is not limited thereto. In addition, in other embodiments, before performing image synthesis processing on a plurality of images, the processor 140 may also perform image offset correction processing or other image grouping, etc., to acquire a high dynamic range image having good visual effects.

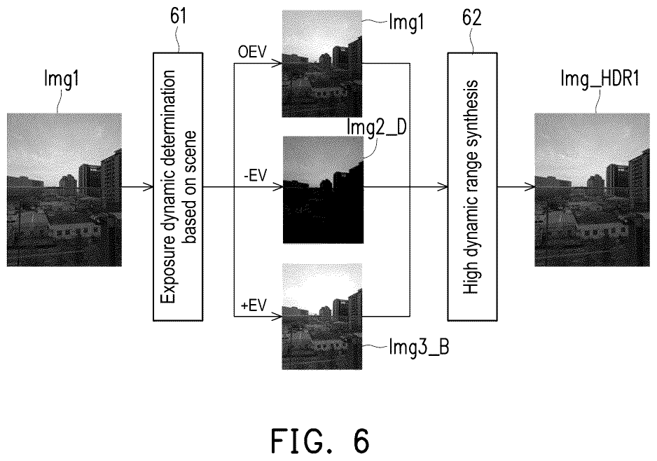

Please refer to FIG. 6, FIG. 6 is a schematic diagram of generating a high dynamic range image shown according to an embodiment of the disclosure. The processor 140 may control the image capture device 120 to capture a first image Img1 according to the initial exposure value “+0 EV”. In operation 61, the processor 140 may determine a target exposure value “+EV” for increasing the exposure and a target exposure value “−EV” for decreasing the exposure according to the method of an embodiment above. The processor 140 may control the image capture device 120 to capture a second image Img2_D according to the target exposure value “−EV”. The processor 140 may control the image capture device 120 to capture another second image Img2_B according to the target exposure value “+EV”. In operation 62, the processor 140 may synthesize the first image Img1, the second image Img2_B, and the second image Img2_D into a high dynamic range image Img_HDR1 according to a high dynamic range image synthesis algorithm.

Based on the above, in an embodiment of the disclosure, the exposure state of each color channel may be determined according to the cumulative distribution function of each color channel. When the exposure state of one of the color channels is overexposed or underexposed, the target exposure value is determined according to the cumulative distribution function of the color channel. Thereafter, the high dynamic range image may be synthesized from the images captured according to the target exposure value. Accordingly, the high dynamic range image may highly restore the scene color and may avoid the situation in which the high dynamic range image has excessive luminance suppression or excessive luminance enhancement.

Although the disclosure has been described with reference to the above embodiments, it will be apparent to one of the ordinary skill in the art that modifications and variations to the described embodiments may be made without departing from the spirit and scope of the disclosure. Accordingly, the scope of the disclosure will be defined by the attached claims not by the above detailed descriptions.

What is claimed is:

1. An exposure control method for generating a high dynamic range image, for an electronic device comprising an image capture device, the method comprising:
acquiring a first image according to an initial exposure value via the image capture device;
generating cumulative distribution functions of a plurality of color channels and a cumulative distribution function of a luminance channel according to the first image;
determining whether an exposure state of each of the color channels is overexposed or underexposed according to the cumulative distribution functions of the plurality of color channels and the cumulative distribution function of the luminance channel;
determining a target exposure value according to the cumulative distribution function of one of the plurality of color channels and the cumulative distribution function of the luminance channel when the exposure state of the one of the plurality of color channels is overexposed or underexposed; and
capturing a second image according to the target exposure value, and synthesizing a high dynamic range image using the first image and the second image.

2. The exposure control method for generating the high dynamic range image of claim 1, wherein the step of determining whether the exposure state of each of the plurality of color channels is overexposed or underexposed according to the cumulative distribution functions of the plurality of color channels and the cumulative distribution function of the luminance channel comprises:
acquiring a plurality of color channel values from the cumulative distribution functions of the plurality of color channels respectively according to a preset cumulative probability;
acquiring a target luminance value from the cumulative distribution function of the luminance channel according to the preset cumulative probability; and
determining whether the exposure state of each of the plurality of color channels is overexposed or underexposed according to a comparison result between the plurality of color channel values and the target luminance value.

3. The exposure control method for generating the high dynamic range image of claim 2, wherein the step of determining whether the exposure state of each of the plurality of color channels is overexposed or underexposed according to the comparison result between the plurality of color channel values and the target luminance value comprises:
determining the exposure state of the one of the plurality of color channels to be overexposed when one of the plurality of color channel values is greater than the target luminance value, wherein the target luminance value is determined according to a first preset cumulative probability.

4. The exposure control method for generating the high dynamic range image of claim 2, wherein the step of determining whether the exposure state of each of the plurality of target color channels is overexposed or underexposed according to the comparison result between the plurality of color channel values and the target luminance value comprises:
determining the exposure state of the one of the plurality of color channels to be underexposed when one of the plurality of color channel values is less than the target luminance value, wherein the target luminance value is determined according to a second preset cumulative probability.

5. The exposure control method for generating the high dynamic range image of claim 1, wherein the step of determining the target exposure value according to the cumulative distribution function of the one of the plurality of color channels and the cumulative distribution function of the luminance channel when the exposure state of the one of the plurality of color channels is overexposed or underexposed comprises:
determining a first exposure value according to the cumulative distribution function of the luminance channel;
acquiring a target color channel value from the cumulative distribution function of the one of the plurality of color channels according to a preset cumulative probability when the exposure state of the one of the plurality of color channels is overexposed or underexposed;
determining a second exposure value according to the target color channel value and a number of pixels of the target color channel value; and
adjusting the first exposure value based on the second exposure value to determine the target exposure value.

6. The exposure control method for generating the high dynamic range image of claim 5, wherein the step of determining the second exposure value according to the target color channel value and the number of pixels of the target color channel value comprises:
acquiring a target luminance value from the cumulative distribution function of the luminance channel according to the preset cumulative probability;
determining the second exposure value according to the target color channel value, the number of pixels of the target color channel value, the target luminance value, and a number of pixels of the target luminance value.

7. The exposure control method for generating the high dynamic range image of claim 6, wherein the step of determining the second exposure value according to the target color channel value, the number of pixels of the target color channel value, the target luminance value, and the number of pixels of the target luminance value comprises:
determining a pixel ratio of the target color channel value according to the number of pixels of the target color channel value;
determining a pixel ratio of the target luminance value according to the number of pixels of the target luminance value;
acquiring a first product between the target luminance value and the pixel ratio of the target luminance value;
acquiring a second product between the target color channel value and the pixel ratio of the target color channel value; and
determining the second exposure value according to a ratio between the first product and the second product.

8. The exposure control method for generating the high dynamic range image of claim 5, wherein the step of adjusting the first exposure value based on the second exposure value to determine the target exposure value comprises:
determining the target exposure value according to a sum of an adjustment limit value and the first exposure value when the second exposure value is greater than the adjustment limit value; and
determining the target exposure value according to a sum of the second exposure value and the first exposure value when the second exposure value is not greater than the adjustment limit value.

9. The exposure control method for generating the high dynamic range image of claim 5, wherein the step of adjusting the first exposure value based on the second exposure value to determine the target exposure value comprises:
determining the target exposure value according to a weighted sum of the second exposure value and the first exposure value.

10. The exposure control method for generating the high dynamic range image of claim 1, further comprising:
determining the target exposure value according to the cumulative distribution function of the luminance channel when the exposure state of each of the plurality of color channels is not overexposed nor underexposed.

11. An electronic device, comprising:
an image capture device; and
a processor coupled to the image capture device, and configured to:
acquire a first image according to an initial exposure value via the image capture device;
generate cumulative distribution functions of a plurality of color channels and a cumulative distribution function of a luminance channel according to the first image;
determine whether an exposure state of each of the color channels is overexposed or underexposed according to the cumulative distribution functions of the plurality of color channels and the cumulative distribution function of the luminance channel;
determine a target exposure value according to the cumulative distribution function of one of the plurality of color channels and the cumulative distribution function of the luminance channel when the exposure state of the one of the plurality of color channels is overexposed or underexposed; and
capture a second image according to the target exposure value, and synthesize a high dynamic range image using the first image and the second image.
